(19) United States
(12) Patent Application Publication
(10) Pub. No.: US 2024/0230866 A1
(43) Pub. Date: Jul. 11, 2024

(54) ONLINE CALIBRATION OF MISALIGNMENT BETWEEN VEHICLE SENSORS

(71) Applicant: GM Cruise Holdings LLC, San Francisco, CA (US)

(72) Inventors: Zhonghua Ma, San Jose, CA (US); Xiaoyu Zhou, San Francisco, CA (US); Himil Narayan Sheth, San Francisco, CA (US)

(73) Assignee: GM Cruise Holdings LLC, San Francisco, CA (US)

(21) Appl. No.: 18/150,707

(22) Filed: Jan. 5, 2023

(51) Int. Cl. G01S 7/497; G01S 17/86; G06T 7/10; G06T 7/80

(52) U.S. Cl. CPC G01S 7/497; G01S 17/86; G06T 7/10; G06T 7/80; G06T 2207/30252

(57) ABSTRACT

Misalignment of camera and light detection and ranging (LIDAR) sensors can impact operations performed by an autonomous vehicle (AV) stack. Misalignment, or deviation from initial alignment over time, can occur in pitch, yaw, and roll dimensions. To address alignment issues, AV sensors may be calibrated before the AV drives on roadways. Additionally, AV sensors may be routinely calibrated at a maintenance facility to detect deviations from initial alignment of the sensors. Offline calibration of AV sensors in maintenance facilities can be inefficient and can significantly increase overhead. Therefore, online calibration of AV sensor misalignment may alleviate some of these concerns. Additionally, online calibration of AV sensors enables efficient monitoring and effective calibration of AV sensor alignment for a whole fleet of AVs while the fleet is on the road.

### BACKGROUND

### Technical field

The present disclosure generally relates to autonomous vehicles (AVs) and, more specifically, to online calibration of misalignment between vehicle sensors.

### Introduction

AVs, also known as self-driving cars, and driverless vehicles, may be vehicles that use multiple sensors to sense the environment and move without human input. Automation technology in AVs may enable vehicles to drive on roadways and to accurately and quickly perceive the vehicle's environment, including obstacles, signs, and traffic lights. Autonomous technology may utilize geographical information and semantic objects (such as parking spots, lane boundaries, intersections, crosswalks, stop signs, and traffic lights) for facilitating vehicles in making driving decisions. The vehicles can be used to pick-up passengers and drive the passengers to selected destinations. The vehicles can also be used to pick-up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples.

Furthermore, the skilled artisan will appreciate the principles of the present technology as described and explained with additional specificity and detail through the use of the accompanying drawings in which:

FIG. (FIG.) 1 illustrates an exemplary AV having sensors and online sensor calibration, according to some aspects of the disclosed technology;

FIG. 2 is a flow diagram for an exemplary computer-implemented method for monitoring and addressing misalignment of AV sensors, according to some aspects of the disclosed technology;

FIG. 3 is a flow diagram illustrating an exemplary computer-implemented method for performing online calibration of misalignment of AV sensors, according to some aspects of the disclosed technology;

FIG. 4A illustrates points from an exemplary point cloud associated with edges of vehicles projected onto an exemplary camera image having a contour of vehicles in the camera image, according to some aspects of the disclosed technology;

FIG. 4B is a zoomed-in portion of the camera image seen in FIG. 4A, according to some aspects of the disclosed technology;

FIG. 5A illustrates points from another exemplary point cloud associated with edges of vehicles projected onto another exemplary camera image having a contour of vehicles in the camera image, according to some aspects of the disclosed technology;

FIG. 5B is a zoomed-in portion of the camera image seen in FIG. 5A, according to some aspects of the disclosed technology;

FIG. 6 illustrates an example system environment that may be used to facilitate AV operations, according to some aspects of the disclosed technology; and

FIG. 7 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details that provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

AVs can provide many benefits. For instance, AVs may have the potential to transform urban living by offering an opportunity for efficient, accessible, and affordable transportation. An AV may be equipped with various sensors to sense the environment surrounding the AV and collect information (e.g., sensor data) to assist the AV in making driving decisions. To that end, the collected information or sensor data may be processed and analyzed to determine a perception of the AV's surroundings, extract information related to navigation, and predict future motions of the AV and/or other traveling agents in the AV's vicinity. The predictions may be used to plan a path for the AV (e.g., from a starting position to a destination). As part of planning, the AV may access map information and localize itself based on location information (e.g., from location sensors) and the map information. The AV may create planned paths based on map information, localization, data from perception, and data from prediction. Subsequently, planned paths can be sent to (vehicle) controls to control the AV (e.g., for steering, accelerating, decelerating, braking, etc.) according to the planned path. Vehicle controls may be referred to herein as controls or a controller.

The operations of perception, prediction, planning, and control of an AV may be implemented using a combination of hardware and software components. For instance, an AV stack or AV compute process performing the perception, prediction, planning, and control may be implemented as software code or firmware code. The AV stack or AV compute process (the software and/or firmware code) may be executed on one or more processor(s) (e.g., general processors, central processors (CPUs), graphical processors (GPUs), digital signal processors (DSPs), ASIC, etc.) and/or any other hardware processing components on the AV. Additionally, the AV stack or AV compute process may communicate with various hardware components (e.g., on-board sensors and control system of the AV) and/or with an AV infrastructure over a network. In some cases, the AV stack may include a layered arrangement of stacks, including stacks such as a perception stack, a prediction stack, a planning stack, and a control stack.

The AV stack, in particular, the perception stack, may perceive the surroundings using a variety of image sensors and depth sensors, such as cameras, light detection and ranging

(LIDAR) sensors, radio detection and ranging (RADAR) sensors. The data streams from these sensors are often fused together in the AV stack to better understand the surroundings, since information from one modality can often help inform decisions and detections based on another modality. Even if the data streams from different modalities are not fused together, the AV stack may make determinations, predictions, and/or decisions based on information from different modalities. When information from different modalities are fused, or when the AV stack is considering information from different modalities, the information from different modalities may be transformed to a same coordinate system, such as a coordinate system that is local to the AV, so that the AV stack can readily refer to a global frame of reference.

To perform the transformation of data streams from different sensors to a same coordinate system, extrinsic matrices of the sensors may be used to perform the transformation. The validity of extrinsic matrices can depend on accuracy of pose information of the sensors relative to the global frame of reference (e.g., the coordinate system of the AV) or to each other. Pose information and extrinsic matrices may be determined or calibrated before the AV operates on the road. As the AV operates on the roadways, the pose of the sensors may deviate from the initial calibrated pose (e.g., due to bumps on the road, natural loosening of mounting mechanisms due to vibrations experienced over time, or tampering). Deviations from the initial calibrated pose may mean that the sensors are misaligned, and the data streams from different sensors cannot be transformed to the same coordinate system accurately. In some cases, minor deviations in the pose (e.g., millimeter differences in position or fraction of a degree differences in rotation) may cause a significant error or offset in the data streams transformed into the same coordinate system.

Misalignment of camera and LIDAR sensors can impact operations performed by an AV stack. Misalignment, or deviation from initial alignment over time, can occur in pitch, yaw, and roll dimensions. To address alignment issues, AV sensors may be calibrated before the AV drives on roadways. Additionally, AV sensors may be routinely calibrated at a maintenance facility to detect these minor deviations from initial alignment of the sensors (e.g., once a month, an AV can be taken offline and routed to a maintenance facility). Such calibrations are referred to herein as offline calibration. In some cases, offline calibration to detect these minor deviations may require special, dedicated maintenance facilities, which can be expensive and labor intensive to maintain. Also, offline calibration, by definition, performs calibration when the AV is not operating normally. In some cases, offline calibration to detect minor deviations in pose information of the sensors can take hours. Requiring frequent offline calibration of AV sensors in maintenance facilities can be inefficient and can significantly increase overhead. Therefore, online calibration of AV sensor misalignment, at least for detecting major deviations from initial alignment of the sensors, may alleviate some of these concerns. Online calibration refers to calibration that can be performed while the AV is on the road or operating normally, e.g., performing an operational assignment (e.g., driving towards a destination to pick-up a passenger or delivery, taking a passenger or delivery to a destination). Online calibration of AV sensors can enable efficient monitoring and effective calibration of AV sensor alignment at scale, i.e., for a whole fleet of AVs while the fleet is on the road.

By providing some online calibration for alignment of AV sensors, the burden to perform offline calibration at a certain frequency may be lessened. For instance, offline calibration may be performed less frequently without sacrificing safety, since online calibration can ensure that significant misalignment errors are detected promptly on the road. Online calibration may also mean that misalignment errors can be monitored over time (as opposed to a one-shot approach), so trends in misalignment errors over time can be identified and detected. In some cases, one or more error thresholds can be set, and responsive remedial actions can be tailored to address different levels of misalignment errors with varying urgency or aggressiveness. Online calibration for a fleet of AVs can mean that misalignment errors can be monitored more holistically across the fleet, enabling better operational decisions to be made for how to best address misalignment errors at the fleet level. For instance, resources can be shifted to perform (high fidelity) calibration for AVs which appear to have a greater misalignment error than others.

Providing online calibration (or continuous calibration) is not trivial. Some other mechanisms for extracting misalignment error may often lead to false positives. False positives may mean that the calibration technique may detect misalignment when there is not significant misalignment. Or the calibration technique may trigger offline calibration when there is tolerable or acceptable misalignment. To reduce false positives, the online calibration technique uses segmented LIDAR point clouds and camera images as input, and the LIDAR point cloud is further filtered to eliminate moving objects, distant objects, and/or vegetation. In some cases, the online calibration technique uses segmented LIDAR point clouds and camera images as input, and the input data are processed to extract features associated with vehicles only. For instance, the calibration technique may consider points in the LIDAR point cloud associated with vehicles and contours of vehicles, only. The resulting filtered LIDAR point cloud can be less sparse and noisy, and may be less susceptible to false positives, e.g., situations where a large misalignment error is detected when the filtered LIDAR point cloud is correlated or matched with a corresponding camera image. Reducing false positives can prevent unnecessary or premature operational assignment terminations and unnecessary offline calibrations.

Various embodiments herein and their advantages may apply to a wide range of vehicles or mobility systems that may experience sensor misalignment (e.g., semi-autonomous vehicles, vehicles with driver-assist functionalities, helicopters, drones, etc.), and not to AVs only.

### Exemplary AV having Sensors and Online Sensor Calibration

FIG. 1 illustrates an exemplary AV having sensors and online sensor calibration, according to some aspects of the disclosed technology. FIG. 1 is a top view of an AV 100. The illustrated AV 100 may have an AV stack 150 that enables the AV 100 to maneuver around its surroundings. The AV stack 150 may take input data streams from sensors, such as cameras and LIDAR sensors, to perform tasks such as perception, prediction, planning, and controls. In the example shown, the AV 100 has four cameras and four LIDAR sensors mounted on the top of the AV 100. Other numbers of sensors may be provided. The cameras and LIDAR sensors can be positioned at different locations in space, and can be pointed towards different directions (i.e., different headings). In other words, pose or pose information for the cameras and LIDAR sensors may be different. For example, camera 106 may have a position x1, y1, and z1, and a heading corresponding to arrow 130. LIDAR sensor 108 may have a position x2, y2, and z2, and a heading corresponding to arrow 140.

As discussed previously, it can be beneficial to transform data streams from the cameras and LIDAR sensors to a same coordinate system using extrinsic matrices. Extrinsic matrices may enable the AV stack 150 (or some other component on AV 100) to transform the data streams from different sensors having different coordinate systems to the same coordinate system (i.e., forming a global frame of reference such as one local to the AV 100). Extrinsic matrices for a sensor can include a translation vector (e.g., for transforming position) and a rotation matrix (e.g., for transforming heading). Extrinsic matrices can be determined during initial offline calibration (e.g., before the AV starts driving on the road) based on pose information of the sensor, which can include position (e.g., x, y, z coordinates) and heading measurements (e.g., in quaternions: qx, qy, qz, and qw). Pose information of various sensors and extrinsic matrices that correspond to the sensors can be inferred from sensor data that captures structured calibration targets. Extrinsic matrices may be updated during routine offline calibrations in specialized maintenance facilities through offline calibration, which can sometimes take hours.

Accuracy of the determined extrinsic matrices at calibration of alignment of the sensors (e.g., camera 106 and LIDAR sensor 108), and thus the subsequent transformations of the data streams to the same coordinate system, can depend on accuracy of the pose information. If the pose information of the sensors (e.g., camera 106 and LIDAR sensor 108) changes, the sensors can become misaligned. Misalignment of sensors may mean that the extrinsic matrices can yield significant misalignment errors or offsets when the data streams are transformed into the same coordinate system.

While the AV 100 is operating on the road, the pose of sensors such as camera 106 and LIDAR sensor 108 may physically deviate from their initial pose when the AV 100 was calibrated. For example, natural wear and tear, tampering, and/or mechanical forces that the AV 100 may experience during operation of the AV 100 can cause the sensors to change in position and/or heading. The position of a sensor may move by millimeters to centimeters. The heading of the sensor may change in pitch, yaw, and/or roll dimensions by a fraction of a degree to several degrees.

Such changes in position and heading would result in a change from the initial pose that was used to generate extrinsic matrices for the sensors during initial calibration of alignment of the sensors. The change in pose may lead to physical misalignment of the sensors. Thus, the initially calibrated extrinsic matrices are no longer accurate. The misalignment can mean that inaccurate/invalid extrinsic matrices are being used for transforming the data streams from the sensors into the same coordinate system. A misalignment error or offset would be present when data streams from misaligned sensors are transformed using inaccurate/invalid extrinsic matrices and superimposed onto the same coordinate system.

A small change in pose may lead to a significant misalignment error. If both camera images and LIDAR point clouds are fused or used as inputs in the AV stack 150, performance and operation of the AV stack may be impacted by the misalignment error or offset, if left uncorrected. In some cases, small misalignment errors may be tolerable to the AV stack 150, and performance and operation of the AV stack may not be impacted. However, some larger misalignment errors may mean that the AV 100 should consider terminating an operational assignment gracefully and finding a safe stopping location.

AV 100 may include a calibration controller 170 to manage, control, and trigger the online calibration process for misalignment of AV sensors while the AV 100 is operating on the road. Calibration controller 170 may operate with online sensor calibration 160 to execute an online calibration technique that processes camera images and LIDAR point clouds to determine the misalignment error of AV sensors. Calibration controller 170 may enable or trigger the AV stack 150 to perform certain remedial actions in response to detected misalignment errors.

AV 100 to be calibrated may be referred to as the ego-AV.

### Exemplary Method for Monitoring and Addressing Misalignment of AV Sensors

It may be desirable to measure and monitor the misalignment error while the AV is operating normally or on the road, so that degradations in calibration, e.g., misalignment errors, can be detected, tracked, and addressed promptly. Also, it may be desirable to calibrate and address the misalignment errors at scale for a fleet of AVs without requiring the AVs to be routed to a maintenance facility frequently. An appropriate response may be carried out when a misalignment error meets or crosses an error threshold. More than one error threshold can be provided.

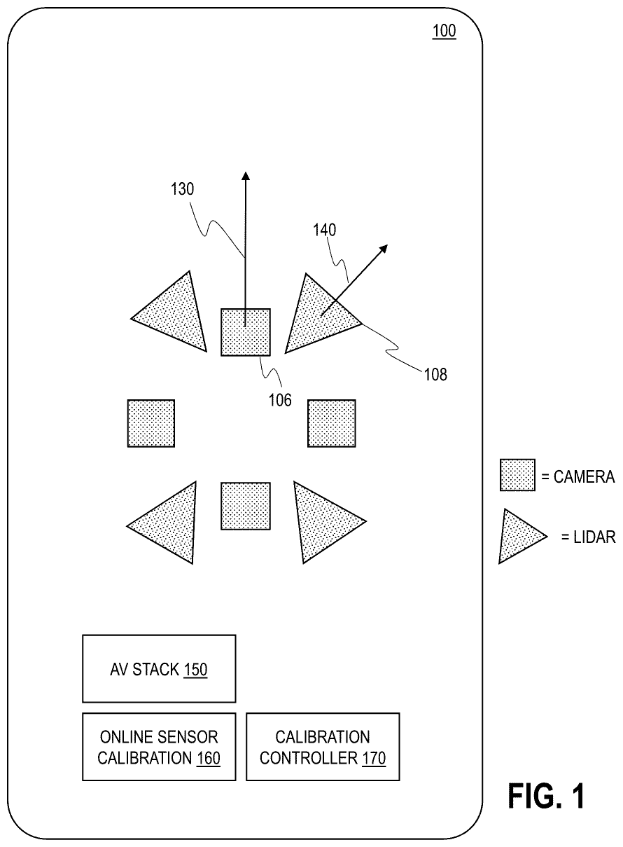

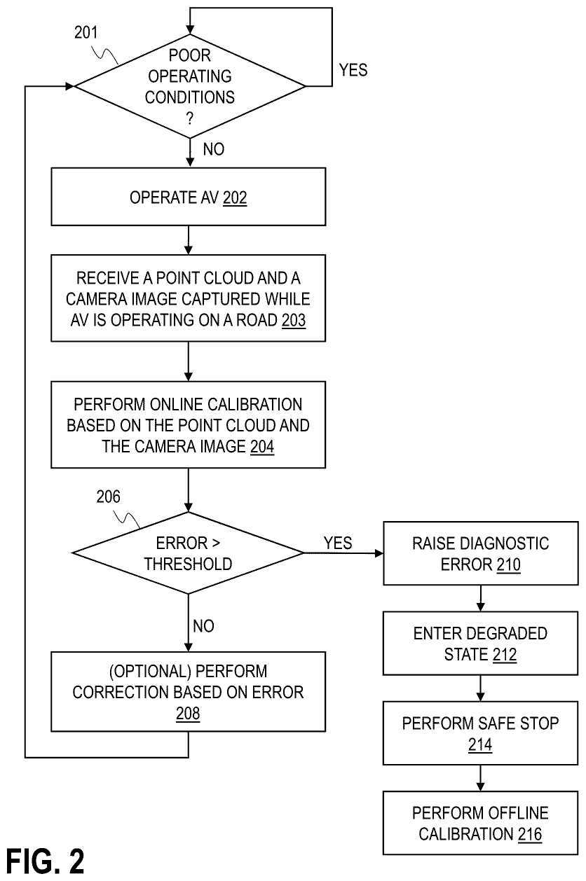

FIG. 2 is a flow diagram for an exemplary computer-implemented method for monitoring and addressing misalignment of AV sensors, according to some aspects of the disclosed technology. The method may be implemented by AV 100, such as AV stack 150, calibration controller 170, and online sensor calibration 160 as seen in FIG. 1. In some cases, at least a portion of the method may be implemented by a (remote) system managing the AV 100 (and other AVs in a fleet of AVs).

In 201, an AV (or a remote system) may check if conditions are suitable or poor for operating the AV. Poor operating conditions may include inclement or poor weather conditions such as fog, rain, snow, etc. Other poor operating conditions may include smoky air, or otherwise unclear or non-ideal atmospheric conditions. If conditions are not suitable or are poor for operating the AV (YES path from 201), the AV may continue to check whether the conditions changes. In some cases, if conditions are not suitable or are poor for operating the AV (YES path from 201), the AV does not operate normally until conditions are suitable for operating the AV (NO path from 201 is followed). For example, the AV may be in an inoperable state. In another example, the AV does not operate on the roadways. In yet another example, the AV may remain stationary or parked.

If the conditions are suitable for operating the AV (NO path from 201), then, in 202, the AV may operate on the road, or operate normally. Operating normally may mean that the AV is not in a degraded state. Operating normally may mean that the AV is using a primary planner. Operating normally may mean that the AV can receive and carry out operational assignments (e.g., pick-up or drop-off passengers and/or deliveries). Operating normally may mean that there are no active critical diagnostic errors or faults. Operating normally may mean that the AV stack is operating as expected or is fully operational. Operating normally may mean that the AV is driving on a road with arbitrary or uncontrolled road scenarios and environments. Operating normally may mean that the AV is not located in a factory setting or in a maintenance facility of the fleet.

Online calibration of misalignment can occur while the AV is operating normally or on the road. Sensor data, collected while the AV is operating normally or on the road, can be used as inputs to perform online calibration. Online calibration may be able to detect significant calibration degradations. In some cases, with sufficient amounts of high quality data, online calibration can detect finer calibration degradations.

The data streams from a LIDAR sensor and a camera sensor, collected while the AV is operating normally or on the road, can be correlated with each other to assess and measure misalignment error. If there is misalignment error or a degradation in calibration, when the data streams are superimposed or projected onto each together into the same coordinate system, the data can exhibit an offset or mismatch.

In 203, a point cloud (e.g., a three-dimensional LIDAR point cloud captured and generated by a LIDAR sensor) and a camera image (e.g., two-dimensional camera image captured by a camera) can be received, e.g., by online sensor calibration 160, as inputs. The LIDAR sensor and the camera may be mounted or fixed on the AV. The LIDAR point cloud and the camera image may be captured while the vehicle is operating on a road. Calibration controller 170 may cause the point clouds and camera images to be saved at certain times while the AV is operating on the road. For instance, calibration controller 170 may monitor the AV stack's perception of the environment to determine whether the surroundings (and thus the point cloud and camera image being saved) are suitable for online calibration. The calibration controller 170 may trigger a point cloud and camera image pair (or a plurality of point clouds and camera images pairs captured at different time instances) to be saved when there are other vehicles in proximity to the AV. In some cases, calibration controller 170 may monitor and ensure the AV is substantially stationary (i.e., not moving) when the point cloud and camera images are captured. In some cases, calibration controller 170 may monitor and ensure the AV is moving at less than a certain velocity (e.g., less than X meters/second). Calibration controller 170 may enable collection and aggregation of input data (e.g., point clouds and camera images) that may be suitable for online calibration.

Preferably, the LIDAR point cloud and the camera image are snapshots of the surroundings that are aligned in time with each other or synchronized, to hold the time variable constant when the LIDAR point cloud and the camera image are compared or correlated with each other. The LIDAR point cloud and the camera image may be captured at substantially the same time. The LIDAR point cloud and the camera image may correspond to substantially the same instant. If the LIDAR point cloud is captured over a first time period, and the camera image is captured over a second time period, the point cloud and the image being aligned in time may mean that the first time period and the second time period partially overlap with each other. If the LIDAR point cloud is captured over a first time period, and the camera image is captured over a second time period, the point cloud and the image being aligned in time may mean that the first time period may include the complete second time period, or the second time period may include the complete first time period (e.g., the first time period and the second time periods completely overlap with each other).

In some cases, the LIDAR point cloud and the camera image may be captured at (slightly) different time instances. If the AV is moving, the LIDAR point cloud and the camera image captured at different times may mean that the LIDAR point cloud is captured when the AV is in a first position, and the camera image is captured when the AV is in a second position different from the first position. The data in the LIDAR point cloud and the camera image may have an ego-AV-motion-induced offset. The ego-AV-motion-induced offset can impact calibration of misalignment between the LIDAR sensor and the camera. The ego-AV-motion-induced offset may be corrected or compensated by odometry readings of the AV. For example, odometry readings of the (ego) AV may provide motion information of the AV (e.g., how quickly the AV was moving, and how the position of the AV has changed between the time instances in space). The motion information of the AV and the timestamps of the LIDAR point cloud and the camera image can be used to remove the ego-AV-motion-induced offset so that only the misalignment error between the LIDAR sensor and the camera remains. Compensating for motion of the AV between the different time instances can enable subsequent correlation of the LIDAR point cloud and the camera image in the same coordinate system.

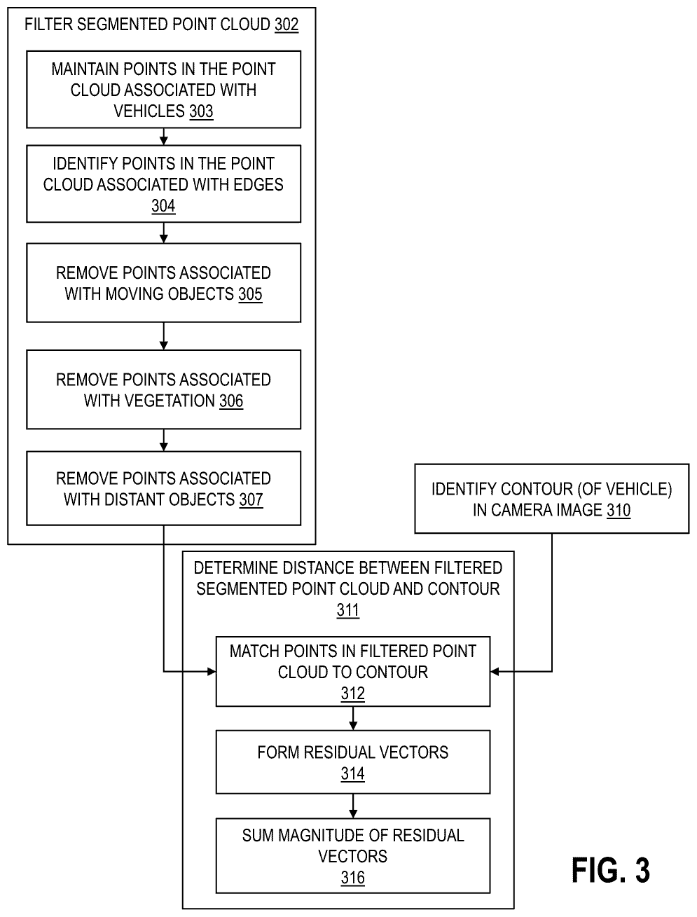

In 204, online calibration may be performed by online sensor calibration 160 based on the LIDAR point cloud and the camera image. Online calibration in 204 may be performed multiple times on multiple LIDAR point cloud and camera image pairs. Online sensor calibration 160 may determine a misalignment error between the LIDAR sensor and the camera based on the input point cloud and camera image. The misalignment error can be a numerical value. In some cases, the greater the value, the worse the misalignment error. Online calibration may correlate data from the LIDAR sensor and data from the camera to determine whether there is misalignment, e.g., offset or mismatch. Details of the calibration technique are described in greater detail with FIG. 3.

In 206, calibration controller 170 may determine whether the misalignment error (determined in 204) crosses or meets an error threshold (e.g., is greater than or equal to an error threshold). Calibration controller 170 may determine whether the misalignment error fails to cross or meet the error threshold (e.g., is less than the error threshold).

In some cases, the calibration controller 170 may examine several misalignment errors (determined from different pairs of point clouds and camera images captured at different time instances), and determine whether a number of the determined misalignments (e.g., a significant majority or a certain percentage of determined misalignments) meets or crosses the error threshold. Applying a voting technique may reduce false positives that could trigger unnecessary remedial actions.

In some cases, calibration controller 170 may examine several misalignment errors, and determine an average of the errors to assess whether the average error meets or crosses the error threshold. Applying an averaging technique may reduce false positives that could trigger unnecessary remedial actions.

For voting or averaging, the calibration controller 170 may perform 203 and 204 several times (e.g., receive multiple point cloud and camera image pairs and perform online calibration on each pair) to determine multiple misalignment errors.

If the misalignment error is meets or crosses a first threshold (e.g., equal to or above a first threshold) (YES path from 206), online sensor calibration 160 may alert the AV stack 150 and/or raise diagnostic error or diagnostic fault (in 210). AV stack 150 may subscribe to alerts or events of the AV, or the AV stack 150 may monitor or listen for active diagnostic errors or faults.

Depending on the diagnostic error or fault that is raised, AV stack 150 may be prompted to enter a degraded state in 212. Calibration controller 170 may in response to the diagnostic error being raised (in 210), cause the vehicle to enter a first degraded state (in 212) and to perform a safe stop maneuver (in 214). Entering a first degraded state may include using a fallback planner in AV stack 150 to plan a path for the AV to perform the safe stop maneuver. For instance, the AV stack 150 may generate a plan for the AV that looks for a suitable location to pull over. The AV stack 150 may generate a plan for the AV that finds a parking spot to park away from traffic.

In some cases, in response to the diagnostic error or fault being raised (in 210), the calibration controller 170 may cause the AV to perform a safe stop maneuver (in 214), and to perform offline calibration for misalignment between the LIDAR sensor and the camera sensor (in 216).

In some cases, in response to the diagnostic error or fault being raised (in 210) and the ego-AV is performing an operational assignment, the operational assignment may be terminated, and continuance of the operational assignment may be performed by a different

AV in the fleet. Another AV available to continue the operational assignment may be routed to a location of the ego-AV.

If the misalignment error is fails to meet or cross the first threshold (e.g., misalignment error is below the first threshold) (NO path from 216), online sensor calibration 160 may perform (online) misalignment correction based on the misalignment error (in 208). In some cases, if the error failing to meet or cross the first threshold means that the error is tolerable to the AV stack 150, correction may be skipped, or may not be necessary.

In some cases, online sensor calibration 160 may be able to extract the change in pose of the sensors, or the change in alignment between the LIDAR sensor and the camera sensor. The change in pose or alignment can be used to determine updated extrinsic matrices for the sensors to correct for the misalignment error. In some cases, the misalignment error can be used to update the extrinsic matrices to correct for the misalignment error (208).

A closed-loop feedback system (e.g., least-means squares error minimization) can be used to adjust the extrinsic matrices so that the misalignment error measured after each adjustment can be reduced and/or minimized.

In some cases, the misalignment errors are monitored over time (e.g., to determine drift) by a fleet management system to determine appropriate adjustments to the extrinsic matrices.

In some cases, more than one error threshold is provided (e.g., over a range of values) in the method. A ladder or set having different types of remedial actions or responses (e.g., with escalating urgency) corresponding to the threshold crossings can be provided. More aggressive or urgent remedial actions may be implemented to respond to higher error threshold crossings.

In some cases, offline calibration having different levels of rigor may be triggered in response to different threshold crossings (e.g., meeting or crossing different thresholds).

In some embodiments, if the misalignment error meets or crosses a second threshold greater than the first threshold (e.g., misalignment error is equal to or is above a second threshold greater than the first threshold), online sensor calibration 160 may cause the vehicle to enter a second degraded state (due to a more severe degradation in calibration) and/or to navigate to a maintenance facility (e.g., to perform offline calibration).

In 208, a correction can be applied to address the misalignment error. For example, sensors may be movable or rotated with electronically controlled actuators. The sensors can be moved or rotated to correct for the misalignment error. A closed-loop feedback system (e.g., least-means squares error minimization) can be used to perform physical adjustments of the LIDAR sensor and the camera to reduce or minimize the misalignment error measured after each adjustment. In some cases, a post-processing procedure can be applied to transform point clouds from the LIDAR sensor and the camera images from the camera based on the misalignment error.

If the error threshold is not met nor crossed (NO path from 206), the method may return to 201 to check for operating conditions and allow for the AV to continue to operate normally in 202.

### Exemplary Method for Performing Online Calibration of Misalignment of AV Sensors

Preferably, the calibration technique is an online technique that can be applied while the AV is operating normally, and can use sensor data collected while the AV is on the road. The calibration technique may be applied even when the AV is in an arbitrary road environment (and not in a controlled calibration-specific facility with carefully designed camera and LIDAR calibration targets). In addition, the calibration technique for measuring and monitoring the misalignment error is preferably robust against false positives, and can detect misalignment errors with confidence.

FIG. 3 is a flow diagram illustrating an exemplary computer-implemented method for performing online calibration of misalignment of AV sensors, according to some aspects of the disclosed technology. The method may be implemented by AV 100, such as online sensor calibration 160 as seen in FIG. 1. In some cases, at least a portion of the method may be implemented by a (remote) system managing the AV 100 (and other AVs in a fleet of AVs). The method of online calibration improves upon other techniques by leveraging segmentation and object classification (e.g., utilizing machine learning and/or statistical techniques) in the AV stack 150 to filter the point cloud and identify features in the camera image. The method can improve upon other techniques by using features associated with vehicles only. In some cases, segmentation and object classification data may be available in the perception stack of the AV stack 150. Online calibration can subscribe to the outputs generated by the perception stack to help identify salient features in the point cloud and the camera image for the calibration.

One aspect of the calibration technique involves (spatially) matching or correlating features in the point cloud and features in the camera image with each other to assess misalignment or offset. Leveraging additional information from segmentation and object classification, the features extracted from the LIDAR point cloud and the camera image are potentially less noisy than other techniques. When the features from the filtered point cloud and features in the camera image are correlated with each other to determine misalignment errors, the technique results in fewer false positives, and the method can more accurately detect misalignment errors with confidence.

Online sensor calibration 160 receives (segmented) LIDAR point cloud captured by a LIDAR sensor and a (segmented) camera image captured by a camera. The LIDAR sensor and the camera may be mounted on an AV, and the point cloud and the camera image may be captured at substantially the same time while the vehicle is operating normally.

A segmented LIDAR point cloud may have points in a three-dimensional space, where each point can be labeled with a classification. Points in the segmented LIDAR point cloud can belong to certain classes or types of objects. Point cloud data may be segmented by a segmentation process or an object classification process. In some cases, the segmented LIDAR point cloud may be clustered, and clusters of points in the segmented LIDAR point cloud correspond to certain objects. Examples of classes or types of objects may include: moving objects, buildings, road surfaces, road signs, pedestrians, vehicles, bicycles, motorcycles, animals/pets, vegetation, etc. The AV stack 150 may identify clusters of points in the point cloud, and associate/attach a classification to each cluster. The clusters may be matched against certain patterns or templates that are associated with different classes or objects. A strong match between a cluster and a pattern/template of a class of objects may indicate with high confidence that a certain cluster belongs to a certain class. In some cases, the clusters or the point cloud may be provided as input to a trained model (e.g., utilizing deep learning) to generate a segmented point cloud. The trained model may determine probabilities that a given point belongs to a class. In some cases, LIDAR point clouds may be segmented and labeled by leveraging data from the camera image (e.g., in the form of sensor fusion). Segmentation of the LIDAR point cloud can be performed by classifying clusters of points in the LIDAR point cloud based on data generated by the one or more LIDAR sensors, and/or data generated by the one or more cameras.

In 302, a segmented LIDAR point cloud can be filtered by online sensor calibration 160. The objective of filtering the point cloud data is to identify salient features that can be used for matching against the features in the camera image. Additionally, filtering can remove noisy data that may cause false positives. A variety of filtering techniques are described herein, which may be used in different combinations to generate a filtered segmented point cloud with salient features. In some cases, filtering can make use of the segmentation and object classification data associated with the LIDAR point cloud to remove certain points in the point cloud quickly.

In some embodiments, leveraging segmentation and object classification data associated with the LIDAR point cloud and the camera image, filtering in 302 may include filtering out points which are not associated with vehicles, and/or maintaining or keeping points which are associated with vehicles (303). Additionally, contours of vehicles are identified in 310. Filtering out non-vehicle points in the point cloud can beneficially allow the calibration method to focus on determining the misalignment error appearing with vehicles only. Vehicles are relatively large, smooth objects, whose silhouettes can appear strongly and in a well-defined manner as discontinuities in the point cloud. Vehicles can also have well-defined contours corresponding to perimeters in the camera image. Analyzing features associated with vehicles and contours associated with vehicles can help reduce false positives by ensuring that the misalignment error would be readily detectable with fewer false positives, because features associated with vehicles in the point cloud data and in the camera image data can be less noisy than other features.

In some cases, filtering in 302 may include identifying points in the point cloud associated with edges of objects or identifying discontinuities in the point cloud data (304). Such points may be maintained or kept in the filtered segmented point cloud, while other points not associated with edges of objects are removed from the point cloud. If 303 is implemented, points in the point cloud associated with edges or silhouettes of vehicles in 304 may be kept in the filtered segmented point cloud, and points that are not associated with edges or silhouettes of vehicles may be filtered out or removed. The resulting filtered segmented point cloud may include points that correspond to edges or silhouettes of vehicles only. Such points can be used readily as input features for 311.

In some cases, filtering in 302 may include further grooming of the point cloud data to remove noisy data. Removing noisy data from being used as input features for 311 can result in fewer false positives when determining misalignment errors.

In some embodiments, filtering in 302 may further include removing points associated with moving objects (305). Because a LIDAR sensor scans a scene with a laser at high speeds to generate the point cloud, moving objects may have motion artifacts in the point cloud data, thereby making the points in the point cloud associated with moving objects more noisy. Using points that are not associated with moving objects (or associated with stationary objects) can reduce false positives. Leveraging segmentation and object classification data (optionally object tracker information from the AV stack 150), the points associated with moving objects may be removed in 305 (or points associated with stationary objects are kept). If 303 is implemented, points in the point cloud associated with stationary vehicles in 305 may be kept in the filtered segmented point cloud, and points that are not associated with moving vehicles may be filtered out or removed. The resulting filtered segmented point cloud may include points that correspond to edges or silhouettes of stationary vehicles only. Such points can be used readily as input features for 311.

In some embodiments, filtering in 302 may further include removing points associated with vegetation (306) or keeping points not associated with vegetation. Vegetation can lead to sparse noisy point cloud data. If points associated with vegetation are kept, the input features for 311 may be noisier, which can cause more false positives.

In some embodiments, filtering in 302 may further include removing points associated with distant objects (307) or keeping points which are closer to the AV. A threshold depth on the depth, distance, or range value of points in the point cloud can be used to mask or remove points which are too far away from the AV. Points beyond a threshold depth (e.g., points at depths that are equal to or above a threshold depth) can be removed. Points that are not beyond a threshold depth (e.g., points at depths that are less than the threshold depth) may be kept or maintained. Distant objects can lead to sparse noisy point cloud data. If points associated with distant objects are kept, the input features for 311 may be noisier.

Object classification or segmentation may be performed on the camera image to provide a segmented camera image, where each pixel may be labeled. Pixels or regions of the image can belong to certain classes or types of objects. Examples of classes or types of objects may include: moving objects, buildings, road surfaces, road signs, pedestrians, vehicles, bicycles, motorcycles, animals/pets, vegetation, etc. The AV stack 150 may identify or locate objects of interest in the camera image (e.g., create bounding boxes), and classify each identified object (e.g., the bounding box) with a classification. In some cases, a camera image may be provided as input to a trained model (e.g., utilizing deep learning) to generate a segmented camera image. The trained model may determine probabilities that a given pixel belongs to a class. In some cases, edge detection may be performed to aid in identifying contours or perimeters of objects in the camera image. In some cases, image segmentation may be applied to the camera image to segment the image into different regions or sets of pixels that belong to different classes or types of objects. The regions may then be associated with different classes or labels. Regions or sets of pixels may have contours or perimeters that correspond to or silhouettes or boundaries of objects in the camera image.

In 310, a contour corresponding to a silhouette or perimeter of a first object (and optionally additional objects) in the camera image may be identified by online sensor calibration 160. Objective of identifying a contour in the camera image can be to identify features in the camera image that can be matched or correlated against the features in the filtered segmented point cloud.

Preferably, the features in the filtered point cloud and the features in the camera image correspond to the same object so that there is a direct correspondence of the two sets of features. The filtered segmented point cloud may have points corresponding to the silhouette of the first object whose contour is identified in 310.

In some cases, if only vehicles are considered in 302 (e.g., by implementing 303, 304, and 305 in 302), the first object may be another vehicle in the proximity of the vehicle when the camera image is captured. In some cases, identifying in 310 may further include performing object classification or image segmentation to identify the first object in the camera image, e.g., prior to determining pixels that correspond to a contour of the first object. In other words, the camera image may be a segmented camera image.

In some cases, segmentation and object classification data associated with the points in the filtered segmented point cloud can be used to identify objects in the camera image to consider. For instance, after filtering in 302, the filtered segmented point cloud may include points corresponding to silhouettes of three vehicles (e.g., vehicle A, vehicle B, and vehicle C). The identification of the three vehicles may be used to identify the three vehicles in the camera image. In 310, contours of vehicle A, vehicle B, and vehicle C can be identified (contours of other objects in the camera image can be ignored).

In some cases, the identified contours or objects in the camera image in 310 may guide the filtering of the point cloud in 302. If the identified contour in the camera image in 310 corresponds to a first object, then the filtering in 302 may filter out or remove all points which are not associated with an edge or silhouette of the first object, or maintain points which are associated with an edge or silhouette of the first object.

To perform online calibration, online sensor calibration 160 may determine a distance between points of the filtered point cloud and the contour, when the points of the filtered point cloud and the contour are converted using extrinsic matrices into the same coordinate system. The measured distance may represent or correspond to an offset or misalignment between the LIDAR sensor and the camera, since the features are expected to match closely with each other when the extrinsic matrices are accurate.

To determine a distance, online sensor calibration 160 may match features between the filtered point cloud (i.e., the remaining points in the filtered point cloud) and the features of the camera image (i.e., points or pixels of the contour). In some cases, determining in 311 may include applying a random sample consensus (RANSAC) algorithm to match points in filtered point cloud to points in contour (312). RANSAC or other similarly suitable algorithms may searching through different sets of pairings of points in the point cloud to pixels in the contour for a set that yields a lowest aggregate distance overall (or best fit/match). RANSAC or other similarly suitable algorithms can find a best or optimal match or correspondence between features in the filtered point cloud and the features in the camera image. The set of pairings of points in the point cloud to pixels in the contour can have a set of residual vectors that connect the pairings. In some cases, determining in 311 may include forming the residual vectors that can quantify distances between the points in the filtered point cloud to the points in the contour (314). In some cases, determining in 311 may include summing magnitudes of the residual vectors, e.g., distances between the pairings (316). The summed magnitudes can correspond to or represent the misalignment error.

In some cases, online sensor calibration 160 may take other factors (besides the distance determined in 311) into account. In some cases, online sensor calibration 160 may determine a misalignment score that includes the distance determined in 311 and a distance determined in 311 weighted by distance of a center of the first object from a center of the camera image. The former distance determined in 311 can be more sensitive to misalignment in the pitch and yaw dimensions, and the distance determined in 311 weighted by the distance of a center of the first object from a center of the camera image can be more sensitive to misalignment in the roll dimension.

In some embodiments, the method illustrated in FIG. 3 is performed multiple times with many different LIDAR point cloud and camera image pairs to determine multiple misalignment errors. In some cases, the misalignment errors may be aggregated into a single misalignment error (e.g., accumulated and/or averaged). In some cases, the misalignment errors may be tracked over a period of time and trends or significant changes in the misalignment errors may be identified.

### Exemplary Misalignment Errors Illustrated on Camera Images

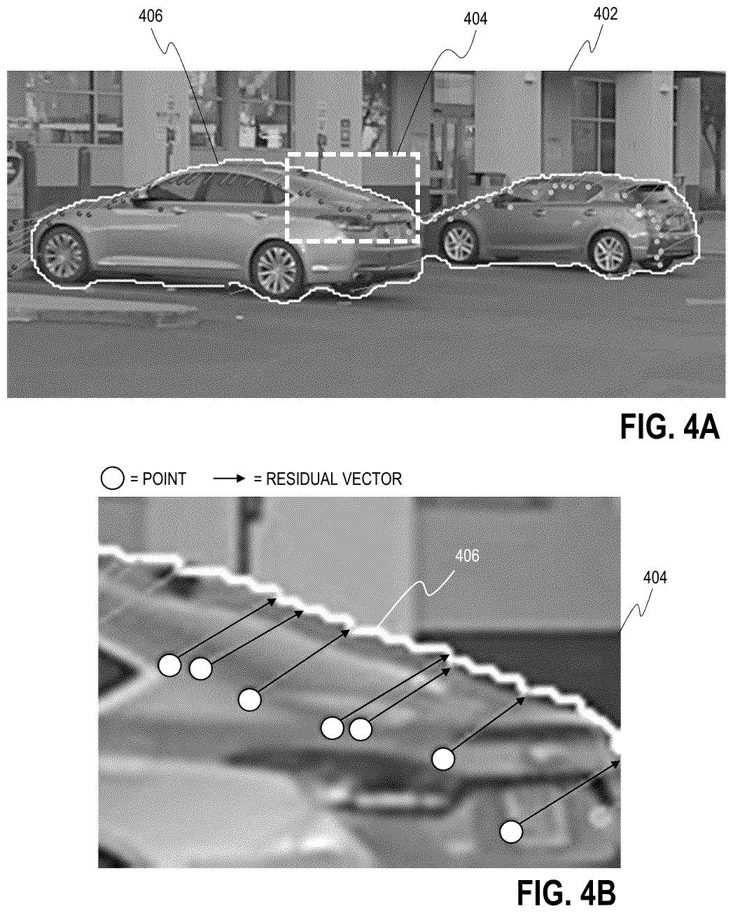

FIG. 4A illustrates points from an exemplary point cloud associated with edges of vehicles projected onto an exemplary camera image 402 having a contour 406 of vehicles in the camera image 402, according to some aspects of the disclosed technology. FIG. 4B is a zoomed-in portion 404 of the camera image seen in FIG. 4A, according to some aspects of the disclosed technology. Points in the filtered segmented point cloud (e.g., point cloud from 302 of FIG. 3) may be superimposed or projected onto the camera image 402. Contour 406 of vehicles in the camera image 402 is shown as a white accentuated line in camera image 402. Several points of the filtered segmented point cloud and residual vectors are illustrated in FIG. 4B. Residual vectors connect points of the filtered segmented point cloud to matched pixels in contour 406. By summing the magnitude of the residual vectors, a measurement of misalignment error can be made, since misalignment appears as a distance or offset when the two sets of features are matched against each other.

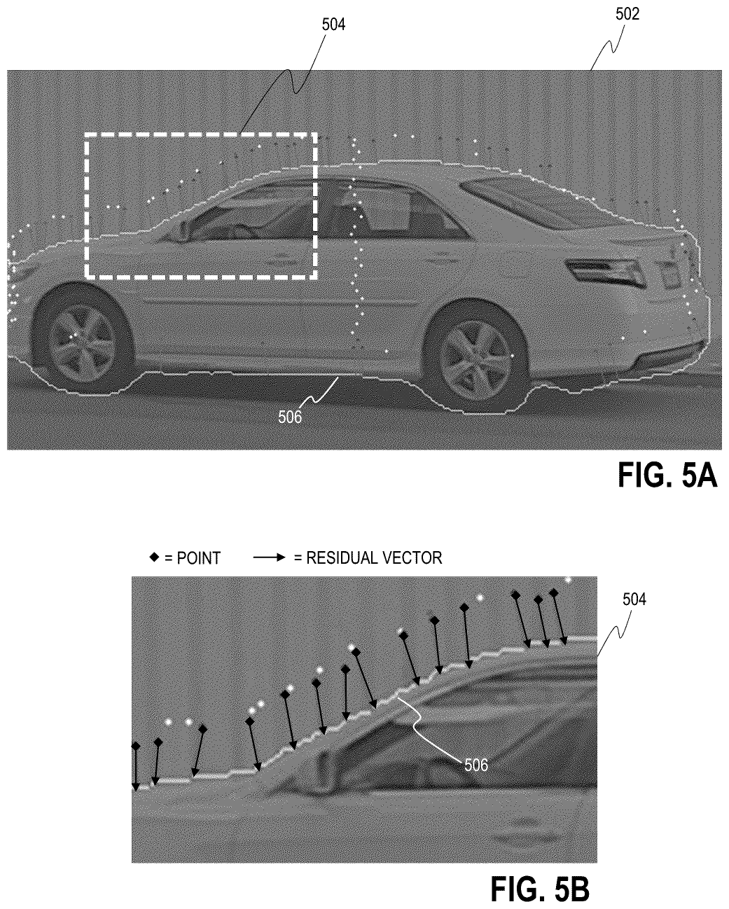

FIG. 5A illustrates points from another exemplary point cloud associated with edges of vehicles projected onto another exemplary camera image 502 having a contour 506 of vehicles in the camera image 502, according to some aspects of the disclosed technology. FIG. 5B is a zoomed-in portion 504 of the camera image seen in FIG. 5A, according to some aspects of the disclosed technology. The example illustrates a pitch error in the alignment between a LIDAR sensor and a camera sensor. Points in the filtered segmented point cloud (e.g., point cloud from 302 of FIG. 3) may be superimposed or projected onto the camera image 502. Contour 506 of vehicles in the camera image 502 is shown as a white accentuated line in camera image 502. Several points of the filtered segmented point cloud and residual vectors are illustrated in FIG. 5B. Residual vectors connect points of the filtered segmented point cloud to matched pixels in contour 506. By summing the magnitude of the residual vectors, a measurement of misalignment error can be made, since misalignment appears as a distance or offset when the two sets of features are matched against each other.

### Exemplary AV Management System

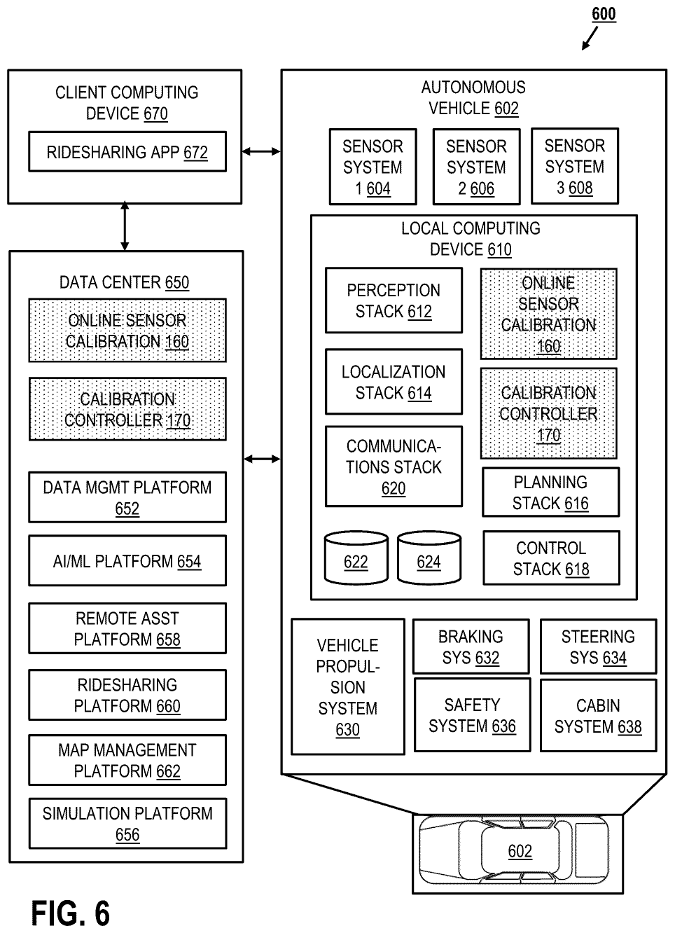

Turning now to FIG. 6, this figure illustrates an example of an AV management system 600, in which some of the aspects of the present disclosure can be implemented. One of ordinary skill in the art will understand that, for the AV management system 600 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 600 includes an AV 602, a data center 650, and a client computing device 670. AV 602 may be an example of AV 100 in the Figures. The AV 602, the data center 650, and the client computing device 670 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 602 may navigate about roadways without a human driver based on sensor signals generated by multiple sensor systems 604, 606, and 608. The sensor systems 604-608 may include different types of sensors and may be arranged about the AV 602. For instance, the sensor systems 604-608 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 may be a camera system, the sensor system 606 may be a LIDAR system, and the sensor system 608 may be a RADAR system. Other embodiments may include any other number and type of sensors.

AV 602 may also include several mechanical systems that may be used to maneuver or operate AV 602. For instance, the mechanical systems may include vehicle propulsion system 630, braking system 632, steering system 634, safety system 636, and cabin system 638, among other systems. Vehicle propulsion system 630 may include an electric motor, an internal combustion engine, or both. The braking system 632 may include an engine brake, a wheel braking system (e.g., a disc braking system that utilizes brake pads), hydraulics, actuators, and/or any other suitable componentry configured to assist in decelerating AV 602. The steering system 634 may include suitable componentry configured to control the direction of movement of the AV 602 during navigation. Safety system 636 may include lights and signal indicators, a parking brake, airbags, and so forth. The cabin system 638 may include cabin temperature control systems, in-cabin entertainment systems, and so forth. In some embodiments, the AV 602 may not include human driver actuators (e.g., steering wheel, handbrake, foot brake pedal, foot accelerator pedal, turn signal lever, window wipers, etc.) for controlling the AV 602. Instead, the cabin system 638 may include one or more client interfaces (e.g., GUIs, Voice User Interfaces (VUIs), etc.) for controlling certain aspects of the mechanical systems 630-638.

AV 602 may additionally include a local computing device 610 that is in communication with the sensor systems 604-608, the mechanical systems 630-638, the data center 650, and the client computing device 670, among other systems. The local computing device 610 may include one or more processors and memory, including instructions that may be executed by the one or more processors. The instructions may make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a planning stack 616, a control stack 618, a communications stack 620, an HD geospatial database 622, and an AV operational database 624, among other stacks and systems. Collectively, a perception stack 612, a mapping and localization stack 614, a planning stack 616, a control stack 618 of the local computing device 610 may provide functionalities described with AV stack 150.

Perception stack 612 may enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 622, other components of the AV, and other data sources (e.g., the data center 650, the client computing device 670, third-party data sources, etc.). The perception stack 612 may detect and classify objects and determine their current and predicted locations, speeds, directions, and the like. In addition, the perception stack 612 may determine the free space around the AV 602 (e.g., to maintain a safe distance from other objects, change lanes, park the AV, etc.). The perception stack 612 may also identify environmental uncertainties, such as where to look for moving objects, flag areas that may be obscured or blocked from view, and so forth.

Mapping and localization stack 614 may determine the AV's position and orientation (pose) using different methods from multiple systems (e.g., GPS, IMUs, cameras, LIDAR, RADAR, ultrasonic sensors, the HD geospatial database 622, etc.). For example, in some embodiments, the AV 602 may compare sensor data captured in real-time by the sensor systems 604-608 to data in the HD geospatial database 622 to determine its precise (e.g., accurate to the order of a few centimeters or less) position and orientation. The AV 602 may focus its search based on sensor data from one or more first sensor systems (e.g., GPS) by matching sensor data from one or more second sensor systems (e.g., LIDAR). If the mapping and localization information from one system is unavailable, the AV 602 may use mapping and localization information from a redundant system and/or from remote data sources.

The planning stack 616 may determine how to maneuver or operate the AV 602 safely and efficiently in its environment. For example, the planning stack 616 may receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 602 from one point to another. The planning stack 616 may determine multiple sets of one or more mechanical operations that the AV 602 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 616 may select from multiple backup plans to carry out. For example, while preparing to change lanes to turn right at an intersection, another vehicle may aggressively cut into the destination lane, making the lane change unsafe. The planning stack 616 could have already determined an alternative plan for such an event, and upon its occurrence, help to direct the AV 602 to go around the block instead of blocking a current lane while waiting for an opening to change lanes.

The control stack 618 may manage the operation of the vehicle propulsion system 630, the braking system 632, the steering system 634, the safety system 636, and the cabin system 638. The control stack 618 may receive sensor signals from the sensor systems 604-608 as well as communicate with other stacks or components of the local computing device 610 or a remote system (e.g., the data center 650) to effectuate the operation of the AV 602. For example, the control stack 618 may implement the final path or actions from the multiple paths or actions provided by the planning stack 616. The implementation may involve turning the routes and decisions (e.g., a trajectory) from the planning stack 616 into commands for the actuators that control the AV's steering, throttle, brake, and drive unit.

The communication stack 620 may transmit and receive signals between the various stacks and other components of the AV 602 and between the AV 602, the data center 650, the client computing device 670, and other remote systems. The communication stack 620 may enable the local computing device 610 to exchange information remotely over a network. The communication stack 620 may also facilitate local exchange of information, such as through a wired connection or a local wireless connection.

In addition, local computing device 610 may implement online sensor calibration 160 and calibration controller 170 as described in the Figures, if it is desirable to implement at least some portions of the methods illustrated in FIGS. 2-3 locally on AV 602.

The HD geospatial database 622 may store HD maps and related data of the streets upon which the AV 602 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes;

permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 624 may store raw AV data generated by the sensor systems 604-608 and other components of the AV 602 and/or data received by the AV 602 from remote systems (e.g., the data center 650, the client computing device 670, etc.). In some embodiments, the raw AV data may include HD LIDAR point cloud data, image or video data, RADAR data, GPS data, and other sensor data that the data center 650 may use for creating or updating AV geospatial data as discussed further below with respect to FIG. 5 and elsewhere in the present disclosure.

The data center 650 may be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 650 may include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 may send and receive various signals to and from the AV 602 and the client computing device 670. These signals may include sensor data captured by the sensor systems 604-608, roadside assistance requests, software updates, ridesharing pick-up and drop- off instructions, and so forth. In this example, the data center 650 includes one or more of a data management platform 652, an Artificial Intelligence/Machine Learning (AI/ML) platform 654, a simulation platform 656, a remote assistance platform 658, a ridesharing platform 660, and a map management platform 662, among other systems.

Data management platform 652 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 may access data stored by the data management platform 652 to provide their respective services.

The AI/ML platform 654 may provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists may prepare data sets from the data management platform 652; select, design, and train machine learning models; evaluate, refine, and deploy the models; maintain, monitor, and retrain the models; and so on.

The remote assistance platform 658 may generate and transmit instructions regarding the operation of the AV 602. For example, in response to an output of the AI/ML platform 654 or other system of the data center 650, the remote assistance platform 658 may prepare instructions for one or more stacks or other components of the AV 602.

The ridesharing platform 660 may interact with a customer of a ridesharing service via a ridesharing application 672 executing on the client computing device 670. Ridesharing platform 660 may provide delivery services as well. The client computing device 670 may be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general-purpose computing device for accessing the ridesharing application 672. The client computing device 670 may be a customer's mobile computing device or a computing device integrated with the AV 602 (e.g., the local computing device 610). The ridesharing platform 660 may receive requests to be picked up or dropped off from the ridesharing application 672 and dispatch the AV 602 for the trip.

Map management platform 662 may provide a set of tools for the manipulation and management of geographic and spatial (geospatial) and related attribute data. The data management platform 652 may receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data may be processed, and map management platform 662 may render base representations (e.g., tiles (2D), bounding volumes (3D), etc.) of the AV geospatial data to enable users to view, query, label, edit, and otherwise interact with the data. Map management platform 662 may manage workflows and tasks for operating on the AV geospatial data. Map management platform 662 may control access to the AV geospatial data, including granting or limiting access to the AV geospatial data based on user-based, role-based, group-based, task-based, and other attribute-based access control mechanisms. Map management platform 662 may provide version control for the AV geospatial data, such as to track specific changes that (human or machine) map editors have made to the data and to revert changes when necessary. Map management platform 662 may administer release management of the AV geospatial data, including distributing suitable iterations of the data to different users, computing devices, AVs, and other consumers of HD maps. Map management platform 662 may provide analytics regarding the AV geospatial data and related data, such as to generate insights relating to the throughput and quality of mapping tasks.

In some embodiments, the map viewing services of map management platform 662 may be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit enroute to a pick-up or drop-off location, and so on.

In addition, data center 650 may include online sensor calibration 160 and/or calibration controller 170 as described in the Figures, if it is desirable to implement at least some portions of the methods illustrated in FIGS. 2-3 remotely, e.g., in the cloud.

In some embodiments, online sensor calibration 160 may be implemented in a system remote from the AV, such as data center 650. Online sensor calibration 160 implemented in a system remote from the AV may benefit from having access to more data (e.g., LIDAR point cloud and camera image pairs spanning over several days) and more computational resources, when compared against online sensor calibration 160 implemented locally on AV 602. When online sensor calibration 160 can access more data, it is possible to select data to be used in the calibration more restrictively to ensure the data being used can yield higher quality and/or accuracy in calibration. One factor relating to the data being used in calibration that can impact quality and/or accuracy in calibration is the velocity of the AV when the data is captured. Preferably, online sensor calibration 160 may take LIDAR point cloud and camera image pairs which are captured when the AV is stationary, or moving very slowly. Pairs captured at slower speeds can yield better calibration results, which in turn can lead to fewer false positives. In some cases, online sensor calibration 160 implemented locally on AV 602 may be utilizing pairs which are captured when velocity of the AV is less than a first value (e.g., 2 meters per second). In some cases, online sensor calibration 160 implemented remotely in the cloud may be utilizing pairs which are captured when velocity of the AV is less than a second value which is smaller than the first value (e.g., 0.3 meters per second), since the online sensor calibration 160 implemented remotely in the cloud may have access to greater amounts of data. By being more selective or restrictive with the data being used for calibration, online sensor calibration 160 implemented remotely in the cloud may obtain calibration results which are of higher quality and/or accuracy. The calibration results obtained by online sensor calibration 160 implemented remotely in the cloud may supplement or cross-check calibration results obtained by online sensor calibration 160 implemented locally on AV 602.

### Exemplary Processor-Based System

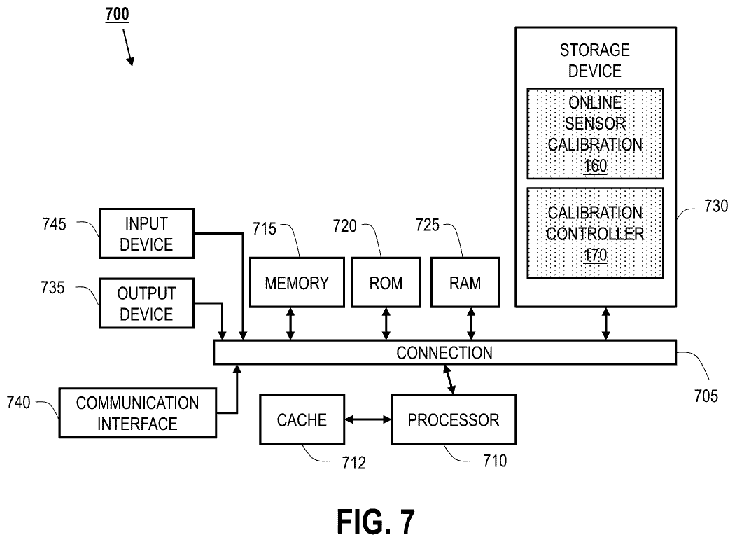

FIG. 7 illustrates an example processor-based system with which some aspects of the subject technology may be implemented. For example, processor-based system 700 may be any computing device making up, or any component thereof in which the components of the system are in communication with each other using connection 705. Connection 705 may be a physical connection via a bus, or a direct connection into processor 710, such as in a chipset architecture. Connection 705 may also be a virtual connection, networked connection, or logical connection.

In some embodiments, computing system 700 represents the local computing device 610 of FIG. 6 and/or the computing systems in data center 650 of FIG. 6. In some embodiments, one or more of the described system components represents many such components each performing some or all of the function for which the component is described. In some embodiments, the components may be physical or virtual devices.

Example system 700 includes at least one processing unit (Central Processing Unit (CPU) or another suitable processor) 710 and connection 705 that couples various system components including system memory 715, such as Read-Only Memory (ROM) 720 and Random-Access Memory (RAM) 725 to processor 710. Computing system 700 may include a cache of high-speed memory 712 connected directly with, in close proximity to, or integrated as part of processor 710.

Processor 710 may include any general-purpose processor and a hardware service or software service, such as executable instructions that implement functionalities described with FIGS. 2-3. The functionalities may be carried out by online sensor calibration 160 and calibration controller 170 encoded in storage device 730. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms known to those of skill in the art. In some instances, multimodal systems may enable a user to provide multiple types of input/output to communicate with computing system 700. Computing system 700 may include communications interface 740, which may generally govern and manage the user input and system output. The communication interface may perform or facilitate receipt and/or transmission wired or wireless communications via wired and/or wireless transceivers.

Storage device 730 may be a non-volatile and/or non-transitory and/or computer-readable memory device and may be a hard disk or other types of computer-readable media which may store data that are accessible by a computer.

Storage device 730 may include software services, servers, services, etc., that when the code that defines such software is executed by the processor 710, it causes the system 700 to perform a function. In some embodiments, a hardware service that performs a particular function may include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### SELECT EXAMPLES

Example 1 is a computer-implemented method for monitoring and addressing misalignment of vehicle sensors, comprising: receiving a LIDAR point cloud captured by a LIDAR sensor, and a camera image captured by a camera, wherein the LIDAR sensor and the camera are mounted on a vehicle, and the LIDAR point cloud and the camera image are captured while the vehicle is operating on a road; performing online calibration based on the LIDAR point cloud and the camera image to determine a misalignment error between the LIDAR sensor and the camera; in response to the misalignment error meeting (or crossing) a first threshold, raising a diagnostic error; and in response to the misalignment error failing to meet (or cross) the first threshold, performing misalignment correction based on the misalignment error.

In Example 2, the computer-implemented method of Example 1 can optionally include the vehicle being an autonomous vehicle.

In Example 3, the computer-implemented method of Example 1 or 2 can optionally include the LIDAR point cloud being segmented by an object classification process.

In Example 4, the computer-implemented method of any one of Examples 1-3 can optionally include performing online calibration comprising: filtering the LIDAR point cloud to remove points which are not associated with vehicles.

In Example 5, the computer-implemented method of any one of Examples 1-4 can optionally include performing online calibration comprising: filtering the LIDAR point cloud to keep points which are associated with edges.

In Example 6, the computer-implemented method of any one of Examples 1-5 can optionally include performing online calibration comprising: filtering the LIDAR point cloud to remove points which are associated with moving objects.

In Example 7, the computer-implemented method of any one of Examples 1-6 can optionally include performing online calibration comprising: filtering the LIDAR point cloud to remove points which are associated with vegetation.

In Example 8, the computer-implemented method of any one of Examples 1-7 can optionally include performing online calibration comprising: filtering the LIDAR point cloud to remove points which are beyond a threshold depth (e.g., points which are at or farther than the threshold depth).

In Example 9, the computer-implemented method of any one of Examples 1-8 can optionally include in response to the diagnostic error being raised, causing the vehicle to enter a first degraded state, and to perform a safe stop maneuver.

In Example 10, the computer-implemented method of any one of Examples 1-9 can optionally include in response to the diagnostic error being raised, causing the vehicle to perform a safe stop maneuver and to perform offline calibration for misalignment between the LIDAR sensor and the camera.

In Example 11, the computer-implemented method of any one of Examples 1-10 can optionally include in response to the misalignment error meeting (or crossing) a second threshold greater than the first threshold, causing the vehicle to enter a second degraded state and to navigate to a maintenance facility.

In Example 12, the computer-implemented method of any one of Examples 1-11 can optionally include the LIDAR point cloud and the camera image being captured at substantially the same time.

Example 13 is a computer-implemented method for performing online calibration of misalignment of vehicle sensors, comprising: filtering a segmented LIDAR point cloud captured by a LIDAR sensor; identifying a contour corresponding to a silhouette of a first object in a camera image captured by a camera, wherein the LIDAR sensor and the camera are mounted on a vehicle, and the point cloud and the camera image are captured while the vehicle is operating normally; determining a distance between points of the filtered point cloud and the contour, wherein the distance corresponds to a misalignment error between the LIDAR sensor and the camera; and performing correction based on the misalignment error.

In Example 14, the computer-implemented method of Example 13 can optionally include the vehicle being an autonomous vehicle.

In Example 15, the computer-implemented method of Example 13 or 14 can optionally include the segmented LIDAR point cloud being clustered, and clusters of points in the segmented LIDAR point cloud corresponding to certain objects.

In Example 16, the computer-implemented method of any one of Examples 13-15 can optionally include filtering the segmented LIDAR point cloud comprising: removing points which are not associated the first object.

In Example 17, the computer-implemented method of any one of Examples 13-16 can optionally include filtering the segmented LIDAR point cloud comprising: removing points which are not associated with vehicles.

In Example 18, the computer-implemented method of any one of Examples 13-17 can optionally include filtering the segmented LIDAR point cloud comprising: keeping points which are associated with edges.

In Example 19, the computer-implemented method of any one of Examples 13-18 can optionally include filtering the segmented LIDAR point cloud comprising: removing points which are associated with moving objects.

In Example 20, the computer-implemented method of any one of Examples 13-19 can optionally include filtering the segmented LIDAR point cloud comprising: removing points which are associated with vegetation.

In Example 21, the computer-implemented method of any one of Examples 13-20 can optionally include filtering the segmented LIDAR point cloud comprising: removing points which are beyond a threshold depth (e.g., points which are at or farther than the threshold depth).

In Example 22, the computer-implemented method of any one of Examples 13-21 can optionally include the filtered point cloud having points corresponding to a silhouette of the first object.

In Example 23, the computer-implemented method of any one of Examples 13-22 can optionally include determining the distance comprising: applying a RANSAC algorithm to match points in filtered point cloud to points in contour; forming residual vectors measuring distances between the points in filtered point cloud to the points in the contour; and summing magnitudes of the residual vectors, wherein the summed magnitudes corresponds to the misalignment error.

In Example 24, the computer-implemented method of any one of Examples 13-23 can optionally include the LIDAR point cloud and the camera image being aligned in time.

In Example 25, the computer-implemented method of any one of Examples 13-24 can optionally include performing the correction comprising: performing a physical adjustment of the LIDAR sensor and the camera which reduces the misalignment error.

In Example 26, the computer-implemented method of any one of Examples 13-25 can optionally include performing the correction comprising: performing a post-processing procedure which transforms point clouds from the LIDAR sensor and/or camera images from the camera based on the misalignment error.

In Example 27, the computer-implemented method of any one of Examples 13-26 can optionally include identifying the contour comprising: performing object classification or image segmentation to identify the first object in the camera image.

Example 28 is a vehicle, comprising: one or more LIDAR sensors; one or more cameras; one or more processors; and one or more storage devices to store point clouds generated by the one or more LIDAR sensor, camera images generated by the one or more cameras, and instructions, which when executed by the one or more processors, cause the one or more processors to perform misalignment calibration comprising: filtering a LIDAR point cloud captured by the one or more LIDAR sensors to maintain points (of the LIDAR point cloud) corresponding to edges, and to remove points (of the LIDAR point cloud) corresponding to moving objects, vegetation, and distant objects; identifying a contour corresponding to a silhouette of a first object in a camera image captured by the one or more cameras, wherein the LIDAR point cloud and the camera image are optionally aligned in time; determining a misalignment error between points of the filtered point cloud and the contour; and performing correction based on the misalignment error.

In Example 29, the vehicle of Example 28 can optionally include the LIDAR point cloud being segmented by a segmentation process or an object classification process.

In Example 30, the vehicle of Example 28 or 29 can optionally include filtering the LIDAR point cloud further comprising maintaining points corresponding to edges of the first object only.

In Example 31, the vehicle of any one of Examples 28-30 can optionally include the first object being another vehicle in the proximity of the vehicle when the camera image is captured.

In Example 32, the vehicle of any one of Examples 28-30 can optionally include the instructions, when executed by the one or more processors, causing the one or more processors to further: perform segmentation of the LIDAR point cloud by classifying clusters of points in the LIDAR point cloud based on data generated by the one or more LIDAR sensors, and/or data generated by the one or more cameras.

Example 33 includes one or more non-transitory computer-readable media storing instructions, when executed by the one or more processing units, cause the one or more processing units to perform any one of the computer-implemented methods of Examples 1-27.

Example 34 is an apparatus comprising means to perform or carry out any one of the computer-implemented methods of Examples 1-27.

What is claimed is:

1. A computer-implemented method for monitoring and addressing misalignment of vehicle sensors, comprising:
receiving a light detection and ranging (LIDAR) point cloud captured by a LIDAR sensor, and a camera image captured by a camera, wherein the LIDAR sensor and the camera are mounted on a vehicle, and the LIDAR point cloud and the camera image are captured while the vehicle is operating on a road;
performing online calibration based on the LIDAR point cloud and the camera image to determine a misalignment error between the LIDAR sensor and the camera;
in response to the misalignment error meeting a first threshold, raising a diagnostic error; and
in response to the misalignment error failing to meet the first threshold, performing misalignment correction based on the misalignment error.

2. The computer-implemented method of claim 1, wherein the LIDAR point cloud is segmented by an object classification process.

3. The computer-implemented method of claim 1, wherein performing online calibration comprises:
filtering the LIDAR point cloud to remove points which are not associated with vehicles.

4. The computer-implemented method of claim 1, wherein performing online calibration comprises:
filtering the LIDAR point cloud to keep points which are associated with edges.

5. The computer-implemented method of claim 1, wherein performing online calibration comprises:
filtering the LIDAR point cloud to remove points which are associated with moving objects.

6. The computer-implemented method of claim 1, wherein performing online calibration comprises:
filtering the LIDAR point cloud to remove points which are associated with vegetation.

7. The computer-implemented method of claim 1, wherein performing online calibration comprises:
filtering the LIDAR point cloud to remove points which are beyond a threshold depth.

8. The computer-implemented method of claim 1, further comprising:
in response to the diagnostic error being raised, causing the vehicle to enter a first degraded state, and to perform a safe stop maneuver.

9. The computer-implemented method of claim 1, further comprising:
in response to the diagnostic error being raised, causing the vehicle to perform a safe stop maneuver and to perform offline calibration for misalignment between the LIDAR sensor and the camera.

10. The computer-implemented method of claim 1, further comprising:
in response to the misalignment error meeting a second threshold greater than the first threshold, causing the vehicle to enter a second degraded state and to navigate to a maintenance facility.

11. The computer-implemented method of claim 1, wherein the LIDAR point cloud and the camera image are captured at substantially the same time.

12. A computer-implemented method for performing online calibration of misalignment of vehicle sensors, comprising:
filtering a segmented light detection and ranging (LIDAR) point cloud captured by a LIDAR sensor to generate a filtered point cloud;
identifying a contour corresponding to a silhouette of a first object in a camera image captured by a camera,
wherein the LIDAR sensor and the camera are mounted on a vehicle, and the point cloud and the camera image are captured while the vehicle is operating normally;
determining a distance between points of the filtered point cloud and the contour, wherein the distance corresponds to a misalignment error between the LIDAR sensor and the camera; and
performing correction based on the misalignment error.

13. The computer-implemented method of claim 12, wherein the segmented LIDAR point cloud is clustered, and clusters of points in the segmented LIDAR point cloud correspond to certain objects.

14. The computer-implemented method of claim 12, wherein filtering the segmented LIDAR point cloud comprises:
removing points which are not associated the first object.

15. The computer-implemented method of claim 12, wherein the filtered point cloud has points corresponding to a silhouette of the first object.

16. The computer-implemented method of claim 12, wherein determining the distance comprises:
applying a random sample consensus algorithm to match points in filtered point cloud to points in the contour;
forming residual vectors measuring distances between the points in filtered point cloud to the points in the contour; and
summing magnitudes of the residual vectors, wherein the summed magnitudes corresponds to the misalignment error.

17. The computer-implemented method of claim 12, wherein performing the correction comprises:
performing a physical adjustment of the LIDAR sensor and the camera which reduces the misalignment error.

18. The computer-implemented method of claim 12, wherein performing the correction comprises:
performing a post-processing procedure which transforms, one or more of: (1) point clouds from the LIDAR sensor and (2) camera images from the camera, based on the misalignment error.

19. The computer-implemented method of claim 12, wherein identifying the contour comprises:
performing object classification or image segmentation to identify the first object in the camera image.

20. A vehicle, comprising:
one or more light detection and ranging (LIDAR) sensors;
one or more cameras;
one or more processors; and
one or more storage devices to store point clouds generated by the one or more LIDAR sensor, camera images generated by the one or more cameras, and instructions, which when executed by the one or more processors, cause the one or more processors to perform misalignment calibration comprising:
generating a filtered point cloud from a light detection and ranging (LIDAR) point cloud captured by the one or more LIDAR sensors, wherein generating comprises maintaining points corresponding to edges, and removing points corresponding to moving objects, vegetation, and distant objects;
identifying a contour corresponding to a silhouette of a first object in a camera image captured by the one or more cameras, wherein the LIDAR point cloud and the camera image are aligned in time;
determining a misalignment error between points of the filtered point cloud and the contour; and
performing correction based on the misalignment error.
